(19) United States
(12) Patent Application Publication
(10) Pub. No.: US 2010/0101271 A1
(43) Pub. Date: Apr. 29, 2010

(54) AIR CONDITIONING SYSTEM WITH AN ABSORPTION COMPRESSOR

(76) Inventor: Vladimir Pogadaev, Jerusalem (IL)

Correspondence Address: Mila Kundel;c/o Vladimir Pogadaev, 2927 Bell, Blvd Bayside, NY, 11360, US

(21) Appl. No.: 12/449,861

(22) PCT Filed: Feb. 14, 2007
(86) PCT No.: PCT/IL07/00200

§ 371 Date: Aug. 31, 2009

(30) Foreign Application Priority Data
Mar. 26, 2006 (IL) 174548

(51) Int. Cl. F25B 17/00

(52) U.S. Cl. 62/477

(57) ABSTRACT

Air conditioning system with an absorption compressor designed for cooling car cabin. The system is utilizing heat energy from a vehicle exhaust gas. The absorption compressor is an oil-Freon absorption device and it works in parallel with the conventional mechanical compressor.

### FIELD OF THE INVENTION

This invention relates to the air conditioning system for a motor vehicle and to the residential air conditioning system with utilization of solar or any other source of energy.

### BACKGROUND OF THE INVENTION

Efficacy of current internal combustion engines is not greater than 33%. Compressors from air conditioning systems use 7-15% of the engine's power, which leads both to increased gas consumption and decreased vehicle's maneuvering ability. Most of the heat energy generated from gas burning is expelled as waste via exhaust into the atmosphere and as heat from the engine's water coolant loop.

Other existing inventions for utilization of the expelled heat energy for cooling of a vehicle cabin use absorption devices with traditional working pairs—ammonia-water, water-LiBr (see patents US2005126211, JP2004161144, JP2004130944, CN1415922, EP1331113, WO9834807), which demands a full replacement of the current compressor air conditioning system. In addition, these air conditioning systems are characterized by a long turning-on lag period (at least 10 minutes) which does not meet current requirements for vehicles' air conditioning systems.

### SUMMARY OF THE INVENTION

Solving problems described above using traditionally working pairs for absorption devices appears to be impossible. Using refrigerant-oil pair allows considerably decreasing measurements of the absorption device, and add it on as an addition to an existing air conditioning compressor.

Oil-refrigerant (for example, refrigerant 134a) solution does not decompose at high temperature and does not corrode main structures, it is non-toxic and non-explosive. The boiling temperature difference for the components of the oil-refrigerant solution is 290° C. under equal pressure it is twice as mach as the one of the water-ammonia solution (133° C.); hence oil-refrigerant solution does not need a rectification. Heat capacity of the oil-refrigerant solution is substantially lower than the water-ammonia's one; also the heat of absorption of refrigerant by oil is lower than the heat of absorption of ammonia by water.

All described above allows to transform an absorption device into an absorption compressor that can be installed on a vehicle, equipped with a standard air conditioner, and to obtain an air conditioning system of minimal size, providing climate comfort while cooling and saving up to 20% of gas while cooling.

### BRIEF DESCRIPTION OF THE DRAWINGS

FIG.1. Scheme of a conventional vehicle air conditioner.

FIG. 2. Scheme of the air conditioning system with an absorption compressor for a vehicle.

### DETAILED DESCRIPTION OF THE INVENTION

New air conditioning system with an absorption compressor includes the standard operation, the standard operation is described first.

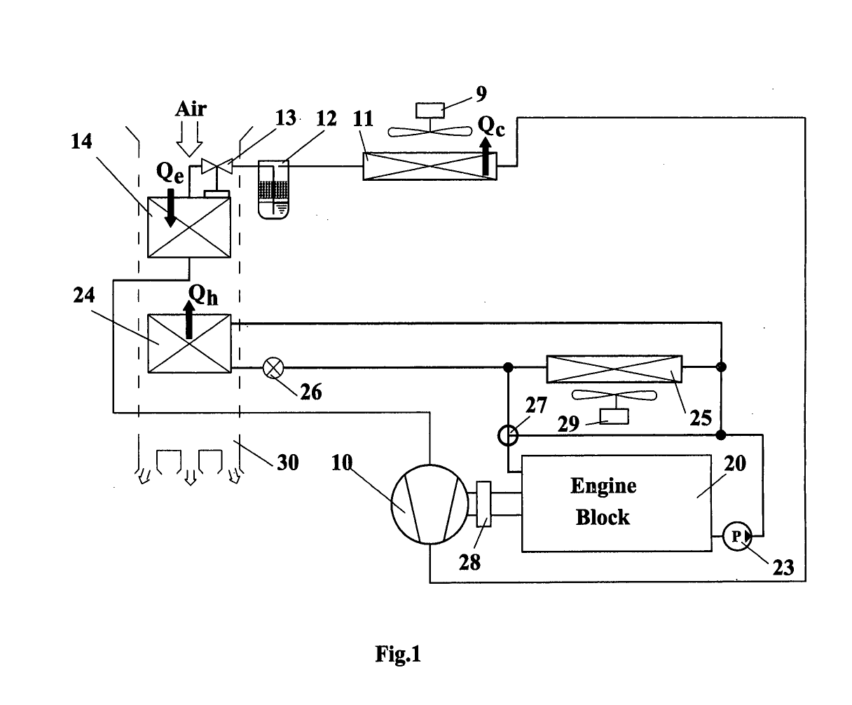

Ref. FIG. 1, at switching on of the compressor 10, high-pressured and high-temperature heated refrigerant vapor is being delivered into the condenser 11, where heat of the condenser Qc is taken by the air flow from the fan 9 while refrigerant liquefies. Liquid refrigerant flows down to the filter-receiver 12, then via the automatic expansion valve 13 gets to the lower part of the evaporator 14 that is located inside passage 30 for the delivery of conditioned air into the vehicle cabin. Inside the evaporator 14 refrigerant evaporates since pressure here is lower than in the rest of the system. Heat Qe for evaporation of liquid refrigerant is taken from the air passed through the evaporator 14. Low-pressure low-temperature refrigerant vapor is sucked in by compressor 10 from the upper part of the evaporator 14, and then the above-described coolant loop (or circulation of refrigerant) cycle repeats itself. In this process air delivered into the cabin is cooled while refrigerant absorbs heat. Mechanical energy for the operation of compressor 10 is provided by the engine 20 via e-magnetic controlled clutch 28.

Heating of the vehicle cabin is done by the use of heat energy Qh from hot water in the engine 20 cooling water loop. At the opening of the water valve 26, hot water gets into the heat exchanger 24, located in the passage 30 for the delivery of conditioned air into the cabin. Hence air delivered in to the cabin is being warmed, while the water in the heat exchanger 24 is being cooled. The engine 20 cooling water loop turns on the water pump 23, the two-way temperature valve 27, the radiator 25 and the fan 29 for the radiator 25, located in the frontal part of the vehicle's engine 20 sector.

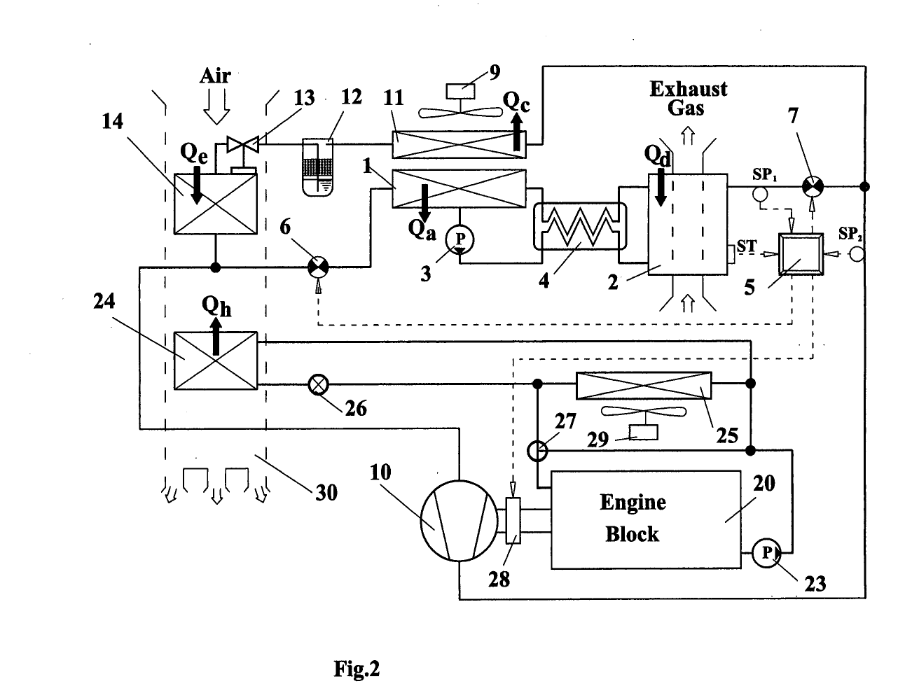

Ref. FIG. 2 shows the air conditioning system according to the present invention. Elements in the cooling contour and the heating contour that are identical to the standard air conditioning system are explained above and marked with the same numbers as in FIG.1. The difference from FIG. 1 is that there is an absorption compressor in parallel to the compressor 10.

The absorption compressor includes absorber 1, located in the frontal part of the vehicle's engine 20 sector, desorber 2, solution pumping 3 and regeneration heat exchanger 4. Connection at the low-pressure side of compressor 10 is performed via electromagnetic controlled valve 6, and at the high-pressure side of the compressor 10—via electromagnetic controlled valve 7.

At the beginning, after the engine is started, electromagnetic controlled valves 6 and 7 are closed. Solution from the lower part of the absorber 1 gets into the pump 3 and is being pumped through heat exchanger 4 into the desorber 2, where the solution is heated by the engine's 20 hot exhaust gas. Because of the functioning of the pump 3 and of the temperature differential between absorber 1 and desorber 2, a pressure differential is being occurred between desorber 2 and absorber 1 that increases until it gets to a steady working value in the limits of 200-250 PSI while the desorber 2 warms up. Because of the pressure differential, the solution gets from the desorber 2 into the heat exchanger 4 and absorber 1 via the internal expansion passage, and then the cycle repeats itself.

When the temperature of the solution and pressure of the refrigerant inside the desorber 2 both get to the established level (approximately in 5 minutes), control module 5 turns off compressor 10 if it was on, and opens electromagnetic controlled valves 6 and 7, that means linking of the absorption compressor into functioning in the coolant loop of the air conditioner.

Description of the absorption compressor working cycle:

Strong oil-refrigerant solution is boiling in the desorber 2. Desorber 2 consists of a double passage-pipe where solution is located in between-the-pipes space; the inner pipe is the engine 20's exhaust. Exhaust gas brings heat Qd necessary for the functioning of the desorber 2. As a result the solution is boiling under the constant pressure of 220 PSI, and high-pressure high-temperature refrigerant vapor is expelled from it and via the electromagnetic controlled valve 7 goes to the coolant loop. This process corresponds to compression and expulsion of refrigerant from the compressor 10.

Weak solution formed in the desorber 2 with temperature of 160° C. under high pressure of refrigerant inside the desorber 2 is being pressed out into the heat exchanger 4. There the weak solution heats the strong one up to the temperature of 120° C. before the strong solution will get to the desorber 2 (while weak solution itself is cooling down to 42° C.). Then the weak solution at the temperature of 42° C. gets into the absorber 1. When going through the inner expansion passage of the absorber 1, the weak solution is being dispersed; while performing the work it is cooling itself down to the temperature of 35° C., and while flowing down absorbs refrigerant, which gets into the absorber 1 via open electromagnetic controlled valve 6. The latter process corresponds to sucking refrigerant vapor into the compressor 10. Absorption heat Qa that is being expelled during the process, is taken off by the cooling air. Working pressure of refrigerant in the absorber 1 goes down to 20 PSI. Inside the absorber 1 the weak solution is being saturated with refrigerant and at the temperature of 35° C. flows down to the lower part of the absorber 1; from there by the pump 3 it is delivered to the desorber 2 via regeneration heat exchanger 4, and then the whole process repeats itself.

With prolonged idle revolutions of the engine 20 when the temperature of the exhaust gas significantly goes down, and this does not allow cooling the cabin effectively, the control board 5 closes electromagnetic controlled valves 6 and 7 and turns compressor 10 on.

Now it is clear, that the absorption compressor with its technical and working parameters corresponds to the function of compressor 10, which in its turn removes temporary delay of the absorption compressor turning on, so that the user doesn't even notice any change in the functioning of the standard air conditioner.

1. Air conditioning system with an absorption compressor for cooling car cabin by utilizing heat energy of the engine's exhaust gas ; absorption compressor is an oil-refrigerant absorption device where oil acts as an absorbent, it includes an absorber, desorber, regeneration heat exchanger and solution pump; absorption compressor is parallel to the conventional mechanical compressor, it is connected via electromagnetic valves; absorption compressor is turning on automatically when the temperature of the solution and refrigerant's pressure in the desorber reach the given values; simultaneously the mechanical compressor is turned off; till then the cooling of a vehicle cabin is provided by the standard air conditioner; system includes controlling board.

2. Air conditioning system with an absorption compressor for cooling residential and offices by utilizing sun light or any kind of heat energy, further as described in claim 1.

3. Air conditioning system with an absorption compressor according to the claims 1 and 2 without the abovementioned mechanical compressor.
